(19) United States
(12) Patent Application Publication
(10) Pub. No.: US 2004/0103047 A1
(43) Pub. Date: May 27, 2004

(54) Model-based systems and methods for calculating raw material usage rates from dynamic inventory trend data

(76) Inventors: Nam Seog Park, Guilderland, NY (US); Patricia Denise Mackenzie, Clifton Park, NY (US)

Correspondence Address: CANTOR COLBURN, LLP, 55 GRIFFIN ROAD SOUTH, BLOOMFIELD, CT, 06002

(21) Appl. No.: 10/306,123

(22) Filed: Nov. 27, 2002

(51) Int. Cl. G06F 17/60

(52) U.S. Cl. 705/28

(57) ABSTRACT

Model-based systems and methods for calculating raw material usage rates from dynamic inventory trend data are described so that materials inventory may be monitored so as to allow for efficient use of the materials. These systems and methods also allow supply chain performance and operations management to be optimized. Materials inventory trend data may first be segmented into segments containing inventory data from one refill of a silo/storage vessel to the next refill. Thereafter, the data in each segment may be serialized to fit on a unified time and inventory scale. Models, preferably cubic regression analysis models, may then be created, and inventory levels on any dates within the models can be estimated therefrom. From these inventory levels, material usage rates may be calculated. These systems and methods may be accessible to users via web-based interfaces.

### FIELD OF THE INVENTION

The present invention relates generally to systems and methods for calculating raw material usage rates. More specifically, the present invention relates to model-based systems and methods for calculating raw material usage rates from dynamic inventory trend data.

### BACKGROUND OF THE INVENTION

Numerous materials are generally consumed during the course of manufacturing a finished product. Such materials may be stored in silos or other storage vessels until their use is required. The level of material inventory remaining in such storage silos or other storage vessels needs to be monitored to ensure that a sufficient quantity of material is available to meet manufacturing requirements. As manufacturing and material costs continue to rise, and manufacturers feel pressure to work with just-in-time inventories, efficient use of materials inventory and monitoring of inventory levels becomes even more critical.

Existing methods for monitoring such inventory levels include sending a person up to the top of a silo/storage vessel, dropping a string down into the silo/storage vessel until it hits the top of the material stored therein, and then estimating the amount of material remaining in the silo/storage vessel therefrom. Other methods include utilizing ultrasound measurements, where an ultrasound sensor located near the top of the silo/storage vessel sends ultrasound waves down to the top of the material, where the ultrasound waves are then reflected back to an ultrasound detector so that measurements of the empty top portion of the silo/storage vessel can be obtained, and the amount of material remaining in the silo/storage vessel can be estimated therefrom.

It is often desirable to be able to calculate material usage rates from inventory trend data. When smooth inventory trends between dates are available, the material usage rate between any two given dates can be easily calculated by taking the difference between the two corresponding inventory levels on those two given dates. However, in real world situations, the inventory trend data becomes very dynamic due to changes in the inventory levels during material refills, among other things. Inherent noise in the inventory level measurement tool may also make it difficult to calculate the material usage rate by taking the difference between the inventory levels on any two given dates. More particularly, if refills of the silo/storage vessel occur between two given dates, the actual inventory levels on those two dates cannot be used to accurately calculate a material usage rate for that time period. Furthermore, errors in calculating material usage rates may arise due to noisy data about inventory levels (i.e., due to small variations in the sensor reading from the way it responds to the uneven surface of the material in the storage vessel). Therefore, it would be desirable to have a way to accurately calculate material usage rates based on dynamic inventory trend data.

There are presently no known, desirable systems and methods for calculating material usage rates based on dynamic inventory trend data. Thus, there is a need for such systems and methods. There is also a need for such systems and method to be model-based. There is yet a further need for such models to utilize cubic regression analysis methods. There is also a need for such systems and methods to allow material inventory levels to be monitored so as to allow for efficient use of the materials. There is still a further need for such systems and methods to allow supply chain performance and operations management to be optimized. Many other needs will also be met by this invention, as will become more apparent throughout the remainder of the disclosure that follows.

### SUMMARY OF THE INVENTION

Accordingly, the above-identified shortcomings of existing systems, methods and models are overcome by embodiments of the present invention, which relates to systems, methods and models for calculating material usage rates based on dynamic inventory trend data. An embodiment of this invention comprises model-based systems and methods. In some embodiments, the models utilize cubic regression analysis methods. Embodiments of the systems and methods of this invention may allow material inventory levels to be monitored so as to allow for efficient use of the materials. Embodiments of the systems and methods of this invention may also allow supply chain performance and operations management to be optimized.

Embodiments of this invention comprise methods for creating a model that can be utilized to calculate a material usage rate for a material from dynamic material inventory data. The methods comprise: segmenting material inventory trend data into segments, wherein the segments comprise material inventory levels from one refill to the next refill; serializing each segment so that each segment fits a unified time and inventory scale; building an individual cubic regression model for each serialized segment; and building a collective cubic regression model by combining all the individual cubic regression models together. The material inventory trend data may be dynamic. The models created in this invention preferably comprise cubic regression analysis models, but it will be apparent to those skilled in the art that various other types of models may also be utilized without deviating from the spirit of this invention, and all such models are deemed to be within the scope of this invention. Once a model is created for a given time period, the model may be utilized to calculate the material usage rate for the material from the material inventory trend data.

Embodiments of this invention also comprise model-based systems and methods for calculating a material usage rate for a material. The systems and methods may comprise: selecting an earlier date and a later date; retrieving a model that comprises both the earlier date and the later date; utilizing the model to determine a first inventory level on the earlier date; utilizing the model to determine a second inventory level on the later date; calculating the material usage rate of the material between the earlier date and the later date. The material usage rate may be calculated by utilizing a difference between the first inventory level on the earlier date and the second inventory level on the later date.

The calculated material usage rate may be sent to at least one Vendor Managed Inventory (VMI) system. The VMI system(s) may comprise multi-tiered services. Furthermore, the VMI system(s) may comprise: monitoring process data for one or more production lines; monitoring material inventory levels for one or more production lines; monitoring material usage for one or more production lines; monitoring energy usage for one or more production lines; monitoring production rates for one or more production lines; and/or calculating a material usage rate for one or more production lines.

The materials that are contained in the silos/storage vessels in embodiments of this invention may comprise an engineering thermoplastic, a liquid, a compressed gas, a food product, grains, concrete aggregates, packaged goods, and many other such materials capable of being stored in silos/storage vessels. The engineering thermoplastic may comprise: a polyester, polyethylene terephthalate (PET), polybutylene terephthalate (PBT), polyethylene naphthalate (PEN), liquid crystal polyester (LCP), a polyolefin, polyethylene (PE), polypropylene (PP), polybutylene, a styrene-type resin, polyoxymethylene (POM), polyamide (PA), polycarbonate (PC), polymethylene methacrylate (PMMA), polyvinyl chloride (PVC), polyphenylene sulfide (PPS), polyphenylene ether (PPE), polyimide (PI), polyamide imide (PAI), polyetherimide (PEI), polysulfone (PSU), polyether sulphone (PES), polyketone (PK), polyether ketone (PEK), polyether ether ketone (PEEK), polyalylate (PAR), polyethernitrile (PEN), a phenol resin (novolac type), a phenoxy resin, a fluorocarbon resin, a thermoplastic elastomer of a polystyrene type, a thermoplastic elastomer of a polyolefin type, a thermoplastic elastomer of a polyurethane type, a thermoplastic elastomer of a polyester type, a thermoplastic elastomer of a polyamide type, a thermoplastic elastomer of a polybutadiene type, a thermoplastic elastomer of a polyisoprene type, a thermoplastic elastomer of a fluorine type, a styrene-type resin, a polycarbonate resin, a polyphenylene ether resin, a polyamide resin, a polyester resin, a polyphenylene sulfide resin, a polyolebi resin, a liquid-crystalline resin, and a phenol-type resin.

Further features, aspects and advantages of the present invention will be more readily apparent to those skilled in the art during the course of the following description, wherein references are made to the accompanying figures which illustrate some preferred forms of the present invention, and wherein like characters of reference designate like parts throughout the drawings.

### DESCRIPTION OF THE DRAWINGS

The systems and methods of the present invention are described herein below with reference to various figures, in which:

FIG. 1 is a flowchart showing the basic steps that may be performed to calculate the material usage rate from dynamic inventory trend data as utilized in embodiments of this invention;

FIG. 2 is a graphical representation showing the dynamic nature of the inventory trend data seen in embodiments of this invention;

FIG. 3 is a flowchart showing the steps that may be performed to build a collective cubic regression model as utilized in embodiments of this invention;

FIG. 4 is a graphical representation showing the serialized data that is created in embodiments of this invention; and

FIG. 5 is a graphical representation showing a web-based user interface that is utilized to monitor silo inventory levels in embodiments of this invention.

### DETAILED DESCRIPTION OF THE INVENTION

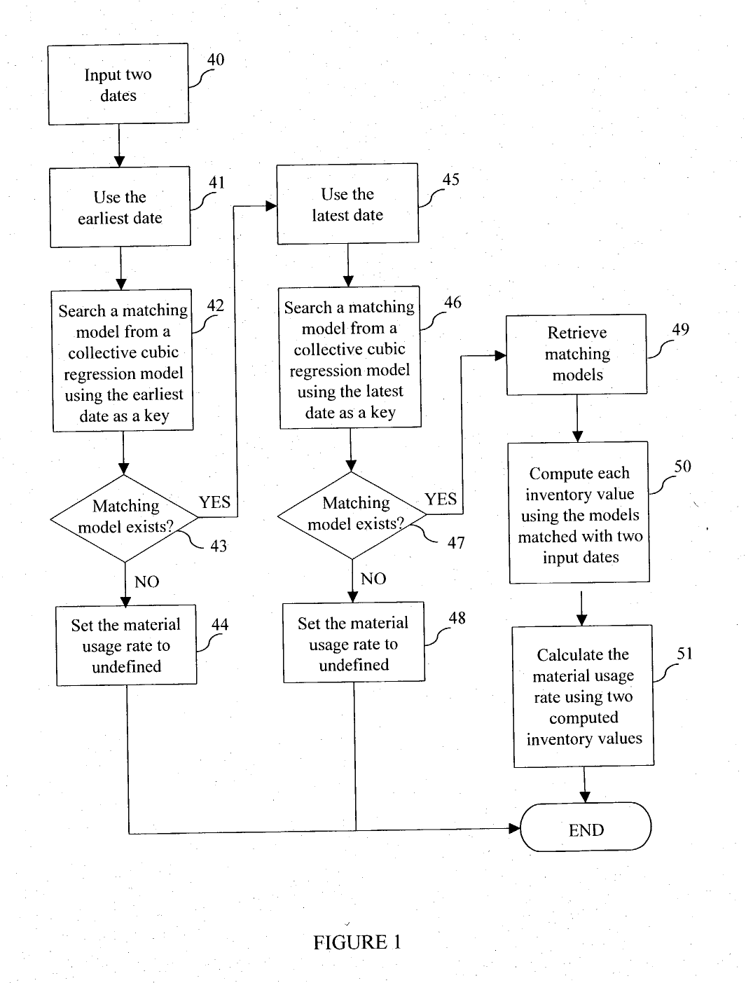

For the purposes of promoting an understanding of the invention, reference will now be made to some preferred embodiments of the present invention as illustrated in FIGS. 1-5, and specific language used to describe the same. The terminology used herein is for the purpose of description, not limitation. Specific structural and functional details disclosed herein are not to be interpreted as limiting, but merely as a basis for the claims as a representative basis for teaching one skilled in the art to variously employ the present invention. Any modifications or variations in the depicted model-based systems and methods for calculating raw material usage rates from dynamic inventory trend data, and such further applications of the principles of the invention as illustrated herein, as would normally occur to one skilled in the art, are considered to be within the spirit of this invention.

The present invention comprises model-based systems and methods for calculating raw material usage rates from dynamic inventory trend data. Material inventory in manufacturing plants may be stored/held in silos or other storage vessels. The amount of material remaining in such silos/storage vessels is preferably monitored so that the consumption rate (i.e., usage rate) of the material(s) contained therein can be determined. It may also be desirable to supply such material inventory level data to a Vendor Managed Inventory (VMI) system.

VMI systems are now commonly utilized as a means of optimizing supply chain performance. In VMIs, the material manufacturer receives data, usually electronic data, that tells the materials manufacturer the material usage rates and material inventory levels of their customers (i.e., the customer in this case is the final product manufacturer). The material manufacturer is then responsible for creating and maintaining an inventory plan, and for generating purchase orders for the final product manufacturer when new material inventory needs to be ordered. One material manufacturer's VMI system comprises a web-based service utilizing sensor technology and 6 Sigma data analysis to optimize supply chain and operations management, resulting in customer value by lowering cost for their customers and maximizing their customer's efficiency.

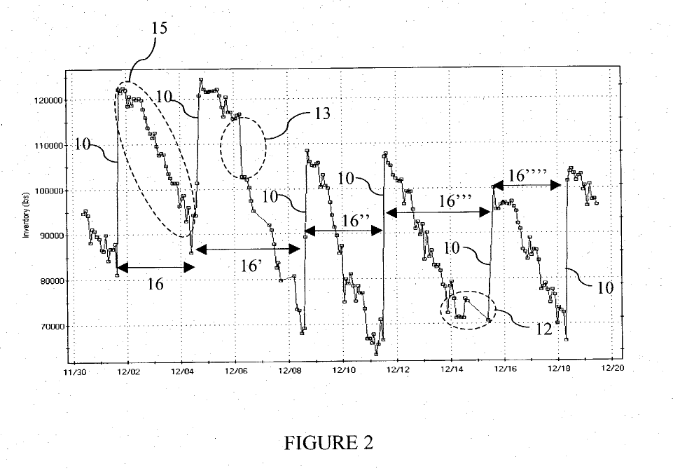

Estimating daily and weekly raw material usage rates is an important part of VMI systems. Knowledge of these usage rates allows customers and their suppliers to estimate when to place an order and/or request a material shipment, and/or to determine what quantity of material is needed. Although VMI systems gather and archive material inventory trend data, estimations of raw material usage rates cannot be easily calculated therefrom because the inventory trend data is dynamic. The archived material inventory trend data is dynamic for a variety of reasons, including: (1) the trend data has irregular step increases when the silo is refilled 10, as shown in FIG. 2; (2) the inventory trend data shows varying rates (i.e., no material usage during periods of plant shutdown, or minimal material usage 12 or maximal material usage 13 due to local weather, labor markets, economic situations, etc.); (3) the gap between successive data points may not be uniform because the system may not be able to gather data for a variety of reasons such as a temporary stop in manufacturing; and (4) the inventory trend data contains noise 15 (i.e., the non linear lines between successive data points), which affects the accuracy of material usage rate calculations.

FIG. 2 shows a graphical representation showing the dynamic nature of the inventory trend data seen in embodiments of this invention. As can be seen here, the inventory level in the silo increases whenever the silo is refilled 10. The inventory level in the silo then decreases 15 as material from the silo is used. The inventory reduction rate changes dramatically depending on the manufacturer's operating conditions. Additionally, the inventory trend data shows some noise 15 (i.e., the trend lines are not very smooth). Such dynamic trend data, as is exists untouched, cannot be used directly to calculate daily or weekly raw material usage rates. However, reliable models for calculating material usage rates from such dynamic inventory trend data may be developed. Such models may comprise collective cubic regression analysis methodology.

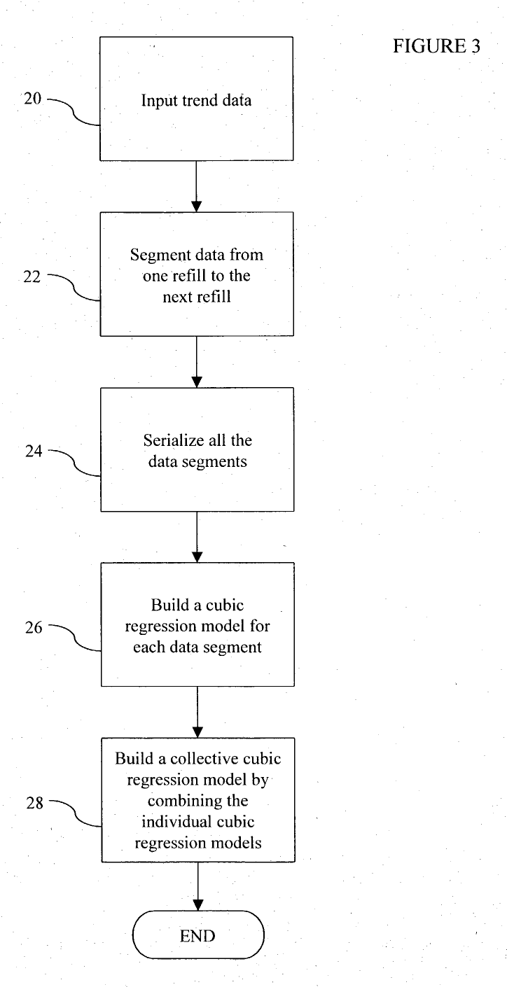

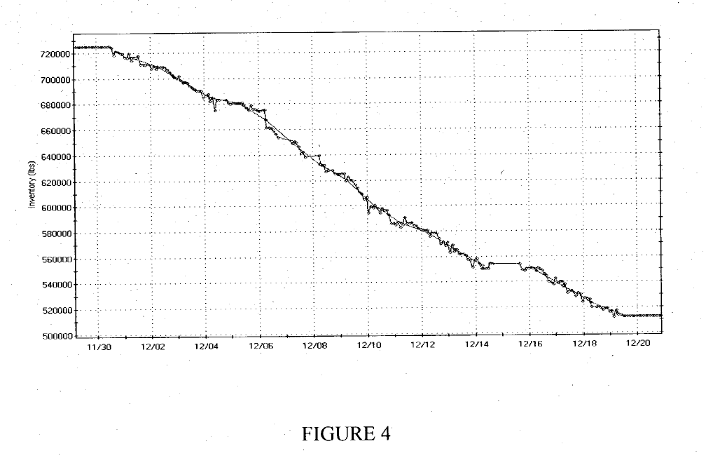

FIG. 3 shows the steps that may be followed to create a collective cubic regression model as utilized in embodiments of this invention. First, inventory trend data must be input 20 into a database or other similar structure capable of allowing for data analysis. Thereafter, the inventory data may be segmented 22 to form segments 16, 16′, 16″, etc., comprising inventory levels from one refill to the next refill. Data segmentation is performed so as to identify where each refill occurred, and to extract each data segment from one refill to the next refill. When data segmentation is complete, all the data segments may be serialized 24, based on the time scale of each data segment. Such serialization produces a series of data segments on unified time and inventory scales. FIG. 4 shows the serialized data that may be created in embodiments of this invention. Individual cubic regression models may be created for each segment 26, and then a collective cubic regression model may be created by combining all the individual segment models together 28. Serialized inventory levels may be obtained for given dates from this collective model, and such inventory levels may be utilized to determine material usage rates between two dates within the collective model.

Once each individual data segment is created, each segment may then be used as input to find a best fitting curve using cubic regression. The result thereof may be a cubic regression model for each individual data segment. Once cubic regression models are created for each individual data segment, a collective cubic regression model may then be created by combining the individual cubic regression models. The attributes contained in a collective cubic regression model may include, for example: the model identification, the start date of the model data, the end date of the model data, the coefficient C, the C₁ coefficient, the C₂ coefficient, and the C₃ coefficient utilized in the cubic regression equation y=C₃x³+C₂x²+C₁x+C that best represents a preferred model of this invention.

Once a collective cubic regression model is created for a given time period, material usage rates between any two dates within the model can be easily calculated. FIG. 1 shows the detailed steps that may be taken, in embodiments of this invention, to calculate a material usage rate between two dates. First, a user may input two dates 40 between which they desire to know the material usage rate. When two dates are input by a user, calculating the material usage rate between those two dates begins with finding existing cubic regression models that can be utilized to calculate inventory levels on each of the two dates input by the user. The earliest date input by the user may be utilized 41 first to see if a model has already been created for a time period including such a date 42. A first matching model may be found 43 if the earliest date input by the user is between the start date of a model and the end date of the same model. If no first matching model is found to exist, the material usage rate for that time period is, as yet, undefined 44, and a model will need to be created before material usage rates for that time period can be accurately calculated.

However, if a first matching model is found to exist already, the attribute values of the first matching model may be saved for later inventory level computations. Thereafter, a second matching model may be found 47 if the latest date input by the user 45 is between the start date of a model and the end date of the same model 46. If no second matching model is found to exist, the material usage rate for that time period is, as yet, undefined 48, and a model will need to be created before material usage rates for that time period can be accurately calculated.

However, if a second matching model is found to exist already, the attribute values of the second matching model may be saved for later inventory level computations. Material usage rates are preferably only calculated by the models of this invention if both a first matching model and a second matching model exist. The first matching model and the second matching model may in fact be one single model that contains inventory data for both dates, or it may be two separate models with each model containing inventory data for one of the desired dates. If no model exists for either of the two dates input/selected by the user, the inventory values for the given dates cannot be defined, and material usage rate calculations may not be performed. If both a first matching model and a second matching model exist, it is then possible to calculate a material usage rate by retrieving the two matching models 49, computing material inventory levels on the two dates that were input by the user 50, and then taking the difference between the two serialized inventory levels obtained from the respective models on the two dates input by the user 51 to calculate a material usage rate for that particular time period.

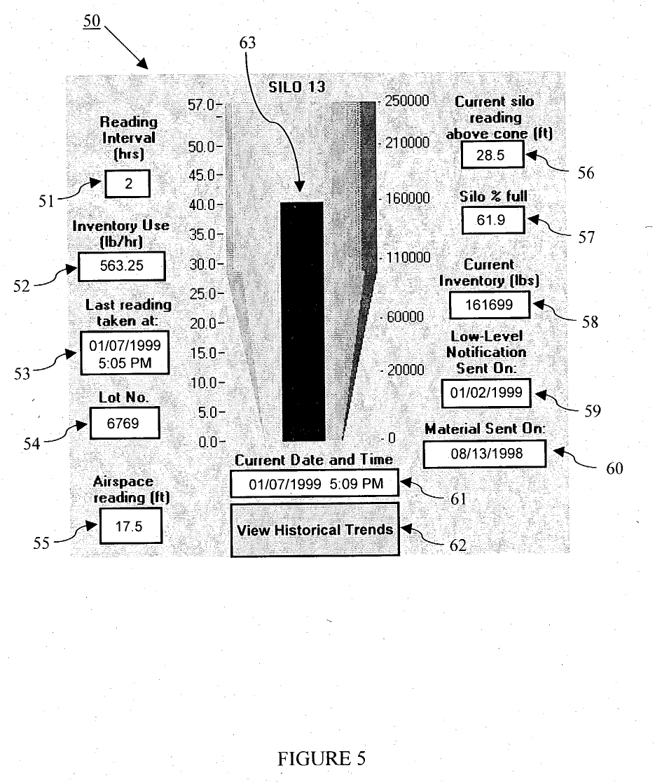

Embodiments of this invention may comprise computer-based and/or web-based user interfaces for viewing, monitoring and/or managing inventory levels in storage silos. One exemplary screen shot 50 of such an interface is shown in FIG. 5. Users may be able to view the current inventory levels in their silos on a computer. This may be accomplished via an intranet, an extranet, the Internet, or the like. In embodiments, users may be able to control how often inventory measurements are taken on the silos 51. Users may also be able to see a variety of information about the inventory level in a given silo, for example, what the current inventory usage rate is 52, when the last inventory level reading/measurement was taken 53, what lot number the material in the silo came from 54, how much airspace is present in the silo 55, what the current silo reading is above the cone 56, what percentage of the silo is currently occupied with material 57, what the current inventory level is 58, when a low-level notification was last sent 59, when the material in the silo was received 60, the current date and time 61, and a visual reading of how much material is currently present in the silo 63. In embodiments, users may also be able to click on a link 62 to view historical inventory trend data for the silo. Numerous other items could also be monitored by or listed on such interfaces, and all such items are deemed to be within the scope of this invention.

The materials that are contained in the silos/storage vessels in embodiments of this invention may comprise an engineering thermoplastic, a liquid, a compressed gas, a food product, grains, concrete aggregates, packaged goods, and many other such materials capable of being stored in silos/storage vessels. The engineering thermoplastic may comprise: a polyester, polyethylene terephthalate (PET), polybutylene terephthalate (PBT), polyethylene naphthalate (PEN), liquid crystal polyester (LCP), a polyolefin, polyethylene (PE), polypropylene (PP), polybutylene, a styrene-type resin, polyoxymethylene (POM), polyamide (PA), polycarbonate (PC), polymethylene methacrylate (PMMA), polyvinyl chloride (PVC), polyphenylene sulfide (PPS), polyphenylene ether (PPE), polyimide (PI), polyamide imide (PAI), polyetherimide (PEI), polysulfone (PSU), polyether sulphone (PES), polyketone (PK), polyether ketone (PEK), polyether ether ketone (PEEK), polyalylate (PAR), polyethernitrile (PEN), a phenol resin (novolac type), a phenoxy resin, a fluorocarbon resin, a thermoplastic elastomer of a polystyrene type, a thermoplastic elastomer of a polyolefin type, a thermoplastic elastomer of a polyurethane type, a thermoplastic elastomer of a polyester type, a thermoplastic elastomer of a polyamide type, a thermoplastic elastomer of a polybutadiene type, a thermoplastic elastomer of a polyisoprene type, a thermoplastic elastomer of a fluorine type, a styrene-type resin, a polycarbonate resin, a polyphenylene ether resin, a polyamide resin, a polyester resin, a polyphenylene sulfide resin, a polyolebi resin, a liquid-crystalline resin, and a phenol-type resin.

As described above, this invention describes model-based systems and methods for calculating raw material usage rates from dynamic inventory trend data. Advantageously, these systems and methods may allow materials inventory to be monitored so as to allow for efficient use of the materials. These systems and methods may also allow supply chain performance and operations management to be optimized.

Various embodiments of the invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. For example, while this invention has been described in terms of models comprising cubic regression analysis methods, numerous other types of mathematical analyses may be implemented in such models. Thus, it is intended that the present invention cover all suitable modifications and variations as come within the scope of the appended claims and their equivalents.

What is claimed is:

1. A method for creating a model that can be utilized to calculate a material usage rate for a material from dynamic material inventory data, the method comprising:
segmenting material inventory trend data into segments, wherein the segments comprise material inventory levels from one refill to the next refill;
serializing each segment so that each segment fits a unified time and inventory scale;
building an individual cubic regression model for each serialized segment; and
building a collective cubic regression model by combining all the individual cubic regression models together.

2. The method of claim 1, wherein the material inventory trend data is dynamic.

3. The method of claim 1, wherein each individual cubic regression model comprises data, wherein the data comprises at least one of: an individual model identification, a start date of the data in the individual cubic regression model, an end date of the data in the individual cubic regression model, a C coefficient of the individual cubic regression model, a C₁ coefficient of the individual cubic regression model, a C₂ coefficient of the individual cubic regression model, and a C₃ coefficient of the individual cubic regression model, wherein each individual cubic regression model utilizes the equation y=C₃x³+C₂x²+C₁x+C.

4. The method of claim 1, wherein the collective cubic regression model comprises one or more individual cubic regression models.

5. The method of claim 1, further comprising:
utilizing the collective cubic regression model to calculate the material usage rate for the material from the material inventory trend data.

6. The method of claim 5, wherein the calculated material usage rate is sent to at least one Vendor Managed Inventory (VMI) system.

7. The method of claim 6, wherein the at least one VMI system comprises a multi-tiered service.

8. The method of claim 6, wherein the at least one VMI system comprises at least one of: monitoring process data for one or more production lines; monitoring material inventory levels for one or more production lines; monitoring material usage for one or more production lines; monitoring energy usage for one or more production lines; monitoring production rates for one or more production lines; calculating a material usage rate for one or more production lines.

9. The method of claim 1, wherein the material comprises at least one of: an engineering thermoplastic, a liquid, a compressed gas, a food product, grains, concrete aggregates, packaged goods, a material capable of being stored in a storage vessel, and a material capable of being stored in a silo.

10. The method of claim 9, wherein the engineering thermoplastic comprises at least one of: a polyester, polyethylene terephthalate (PET), polybutylene terephthalate (PBT), polyethylene naphthalate (PEN), liquid crystal polyester (LCP), a polyolefin, polyethylene (PE), polypropylene (PP), polybutylene, a styrene-type resin, polyoxymethylene (POM), polyamide (PA), polycarbonate (PC), polymethylene methacrylate (PMMA), polyvinyl chloride (PVC), polyphenylene sulfide (PPS), polyphenylene ether (PPE), polyimide (PI), polyamide imide (PAI), polyetherimide (PEI), polysulfone (PSU), polyether sulphone (PES), polyketone (PK), polyether ketone (PEK), polyether ether ketone (PEEK), polyalylate (PAR), polyethernitrile (PEN), a phenol resin (novolac type), a phenoxy resin, a fluorocarbon resin, a thermoplastic elastomer of a polystyrene type, a thermoplastic elastomer of a polyolefin type, a thermoplastic elastomer of a polyurethane type, a thermoplastic elastomer of a polyesters type, a thermoplastic elastomer of a polyamide type, a thermoplastic elastomer of a polybutadiene type, a thermoplastic elastomer of a polyisoprene type, a thermoplastic elastomer of a fluorine type, a styrene-type resin, a polycarbonate resin, a polyphenylene ether resin, a polyamide resin, a polyester resin, a polyphenylene sulfide resin, a polyolebi resin, a liquid-crystalline resin, and a phenol-type resin.

11. A model-based method for calculating a material usage rate for a material, the method comprising:
selecting an earlier date and a later date;
retrieving a model that comprises both the earlier date and the later date;
utilizing the model to determine a first inventory level on the earlier date;
utilizing the model to determine a second inventory level on the later date;
calculating the material usage rate of the material between the earlier date and the later date.

12. The method of claim 11, wherein the material usage rate is calculated by utilizing a difference between the first inventory level on the earlier date and the second inventory level on the later date.

13. The method of claim 11, wherein the calculated material usage rate is sent to at least one Vendor Managed Inventory (VMI) system.

14. The method of claim 13, wherein the at least one VMI system comprises a multi-tiered service.

15. The method of claim 13, wherein the at least one VMI system comprises at least one of: monitoring process data for one or more production lines; monitoring material inventory levels for one or more production lines; monitoring material usage for one or more production lines; monitoring energy usage for one or more production lines; monitoring production rates for one or more production lines; calculating a material usage rate for one or more production lines.

16. The method of claim 11, wherein the material comprises at least one of: an engineering thermoplastic, a liquid, a compressed gas, a food product, grains, concrete aggregates, packaged goods, a material capable of being stored in a storage vessel, and a material capable of being stored in a silo.

17. The method of claim 16, wherein the engineering thermoplastic comprises at least one of: a polyester, polyethylene terephthalate (PET), polybutylene terephthalate (PBT), polyethylene naphthalate (PEN), liquid crystal polyester (LCP), a polyolefin, polyethylene (PE), polypropylene (PP), polybutylene, a styrene-type resin, polyoxymethylene (POM), polyamide (PA), polycarbonate (PC), polymethylene methacrylate (PMMA), polyvinyl chloride (PVC), polyphenylene sulfide (PPS), polyphenylene ether (PPE), polyimide (PI), polyamide imide (PAI), polyetherimide (PEI), polysulfone (PSU), polyether sulphone (PES), polyketone (PK), polyether ketone (PEK), polyether ether ketone (PEEK), polyalylate (PAR), polyethernitrile (PEN), a phenol resin (novolac type), a phenoxy resin, a fluorocarbon resin, a thermoplastic elastomer of a polystyrene type, a thermoplastic elastomer of a polyolefin type, a thermoplastic elastomer of a polyurethane type, a thermoplastic elastomer of a polyester type, a thermoplastic elastomer of a polyamide type, a thermoplastic elastomer of a polybutadiene type, a thermoplastic elastomer of a polyisoprene type, a thermoplastic elastomer of a fluorine type, a styrene-type resin, a polycarbonate resin, a polyphenylene ether resin, a polyamide resin, a polyester resin, a polyphenylene sulfide resin, a polyolebi resin, a liquid-crystalline resin, and a phenol-type resin.

18. The method of claim 11, wherein the model comprise a mathematical algorithm.

19. The method of claim 18, wherein the mathematical algorithm comprises cubic regression analysis.

20. A model-based system for calculating material usage rates for a material, the system comprising:
a means for selecting an earlier date and a later date;
a means for retrieving a model that comprises both the earlier date and the later date;
a means for utilizing the model to determine a first inventory level on the earlier date;
a means for utilizing the model to determine a second inventory level on the later date;
a means for calculating the material usage rate of the material between the earlier date and the later date.

21. The system of claim 20, wherein the material usage rate is calculated by utilizing a difference between the first inventory level on the earlier date and the second inventory level on the later date.

22. The system of claim 20, wherein the calculated material usage rate is sent to at least one Vendor Managed Inventory (VMI) system.

23. The system of claim 22, wherein the at least one VMI system comprises a multi-tiered service.

24. The system of claim 22, wherein the at least one VMI system comprises at least one of: monitoring process data for one or more production lines; monitoring material inventory levels for one or more production lines; monitoring material usage for one or more production lines; monitoring energy usage for one or more production lines; monitoring production rates for one or more production lines; calculating a material usage rate for one or more production lines.

25. The system of claim 20, wherein the material comprises at least one of: an engineering thermoplastic, a liquid, a compressed gas, a food product, grains, concrete aggregates, packaged goods, a material capable of being stored in a storage vessel, and a material capable of being stored in a silo.

26. The system of claim 25, wherein the engineering thermoplastic comprises at least one of: a polyester, polyethylene terephthalate (PET), polybutylene terephthalate (PBT), polyethylene naphthalate (PEN), liquid crystal polyester (LCP), a polyolefin, polyethylene (PE), polypropylene (PP), polybutylene, a styrene-type resin, polyoxymethylene (POM), polyamide (PA), polycarbonate (PC), polymethylene methacrylate (PMMA), polyvinyl chloride (PVC), polyphenylene sulfide (PPS), polyphenylene ether (PPE), polyimide (PI), polyamide imide (PAI), polyetherimide (PEI), polysulfone (PSU), polyether sulphone (PES), polyketone (PK), polyether ketone (PEK), polyether ether ketone (PEEK), polyalylate (PAR), polyethernitrile (PEN), a phenol resin (novolac type), a phenoxy resin, a fluorocarbon resin, a thermoplastic elastomer of a polystyrene type, a thermoplastic elastomer of a polyolefin type, a thermoplastic elastomer of a polyurethane type, a thermoplastic elastomer of a polyester type, a thermoplastic elastomer of a polyamide type, a thermoplastic elastomer of a polybutadiene type, a thermoplastic elastomer of a polyisoprene type, a thermoplastic elastomer of a fluorine type, a styrene-type resin, a polycarbonate resin, a polyphenylene ether resin, a polyamide resin, a polyester resin, a polyphenylene sulfide resin, a polyolebi resin, a liquid-crystalline resin, and a phenol-type resin.

27. The system of claim 20, wherein the model comprise a mathematical algorithm.

28. The system of claim 27, wherein the mathematical algorithm comprises cubic regression analysis.
